(19) United States
(12) Patent Application Publication
(10) Pub. No.: US 2004/0166856 A1
(43) Pub. Date: Aug. 26, 2004

(54) Location system

(76) Inventor: Jarko Niemenmaa, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/657,700

(22) Filed: Sep. 9, 2003

Related U.S. Application Data
(60) Provisional application No. 60/448,534, filed on Feb. 21, 2003.

(51) Int. Cl. H04Q 7/20

(52) U.S. Cl. 455/436; 455/440

(57) ABSTRACT

A method of locating user equipment in a communication network during handover. The method includes requesting the location of the user equipment which is communicating on a first channel and initiating the determination of the location of the user equipment, and handing over the user equipment for communicating on a second channel. The determination of the location of the user equipment is suspended until the handing over has been completed.

### CROSS REFERENCE TO RELATED APPLICATIONS

This application claims priority of U.S. Provisional Patent Application Serial No. 60/448,534, entitled “Improvements in a Location System” filed on Feb. 21, 2003, the contents of which are hereby incorporated by reference.

### BACKGROUND OF THE INVENTION

1. Field of the Invention

The present invention relates to a method and system for locating user equipment within a communications network.

2. Description of the Related Art

A cellular telecommunications system is a communication system that is based on use of radio access entities and/or wireless service areas. The access entities are typically referred to as cells. Examples of cellular telecommunications systems include standards such as the GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access), TDMA/CDMA (Time Division Multiple Access/Code Division Multiple Access) in UMTS (Universal Mobile Telecommunications System), CDMA 2000, i-Phone and so on.

In a cellular system, a base transceiver station (BTS) provides a wireless communication facility that serves mobile stations (MS) or similar wireless user equipment (UE) via an air or radio interface within the coverage area of the cell. As the approximate size and the shape of the cell is known, it is possible to associate the cell to a geographical area. Each of the cells can be controlled by an appropriate controller apparatus.

Elements of the cellular network can be used to provide location information concerning a mobile station and the user thereof. More particularly, the cells or similar geographically limited service areas facilitate the cellular telecommunications system to produce at least a rough location information estimate concerning the current geographical location of a mobile station, as the cellular telecommunications system is aware of the cell with which a mobile station currently associates. Therefore, it is possible to conclude from the location of the cell the geographical area in which the mobile station is likely to be at a given moment. This information is also available when the mobile station is located within the coverage area of a visited or “foreign” network. The visited network may be capable of transmitting location information of the mobile station back to the home network, e.g. to support location services or for the purposes of call routing and charging.

A location service feature may be provided by a separate network element such as a location server which receives location information from at least one of the controllers of the system. If no further computations and/or approximations are made, this would give the location to an accuracy of one cell, i.e. it would indicate that the mobile station is (or at least was) within the coverage area of a certain cell.

However, more accurate information concerning the geographical location of a mobile station may be desired. For example, the United States Federal Communication Commission (FCC) has mandated that wireless service providers have to implement location technologies that can locate wireless phone users who are calling to emergency numbers. Although the FCC order is directed to emergency caller location, other commercial and non-commercial uses for mobile systems, such as fleet management, location-dependent billing, advertising and providing information or navigation applications, might also find more accurate location information useful. As an example of the estimated value of the locations service, reference can be made to a research report by the “Strategis Group” which claims that location-based services would create over USD 16 billion annual worldwide revenues by year 2005.

The accuracy of the location determination may be improved by using results of measurements which define the travel time (or travel time differences) of the radio signal sent by a mobile station to the base station. More accurate location information may be obtained through e.g. by calculating the geographical location from range or range difference (RD) measurements. All methods that use range difference (RD) measurements may also be called TDOA (time difference of arrival) methods such as mathematically RD=c*TDOA, wherein c is the signal propagation speed. Observed time difference (OTD), E-OTD (Enhanced OTD) and TOA (time of arrival) are mentioned herein as examples of technologies that are based on the RD measurements.

The difference between the TOA (time of arrival) and the E-OTD is in that in the TOA the mobile station sends the signal and the network makes the measurements, whereas in the E-OTD the network sends the signals and the mobile station measures them. The mobile stations are provided with appropriate equipment and software to provide information on which the positioning of the mobile station can be based on. The mobile station may communicate the information via the base station to an appropriate network element that may use the information in a predefined manner.

It is also possible to form RD measurements based on other sources, e.g. from GPS (Global Positioning System) pseudo-range measurements.

The measurements are accomplished by a number of base stations (preferably at least three) covering the area in which the mobile station is currently located. The measurement by each of the base stations gives the distance (range) between the base station and the mobile station or distance difference (range difference) between the mobile station and two base stations. Each of the range measurements generates a circle that is centered at the measuring base station, and the mobile station is determined to be located at an intersection of the circles. Each of the range difference measurements by two base stations creates a hyperbola (not a circle as in the range measurements). Thus, if range differences are used in the location calculation, the intersections of the hyperbolas are searched for. In an ideal case and in the absence of any measurement error, the intersection of the circles or the hyperbolas would unambiguously determine the location of the mobile station.

In principle, in the hyperbolic case two hyperbolas (i.e., measurements from three different sites), and in the circular case two circles (i.e., measurements from two different sites) are enough for location estimation. However, circles/hyperbolas can intersect twice, which means that in an ideal case, measurement from one more site is needed for an unambiguous solution unless some prior information is available which is good enough to reject the wrong solution.

As mentioned for TDOA, it is the network that is responsible for making the measurements and has LMUs (Location Measuring Units) to receive signals from the MS and a SMLC (Serving Mobile Location Center) to calculate the location of the MS.

U-TDOA (Uplink Time Difference of Arrival) has been selected for the Emergency 911 method in the USA. The TDOA method is also going to be integrated in the GSM network by adding a new interface to the SMLC and by adding new signals to the GSM standards, for example the 3GPP TS 09.31 V8.5.0 (2001-12) GSM standard. Draft changes to the versions of the standard have already been presented in 3GPP (3^{rd} Generation Partnership Project) meetings.

However, a problem exists if the location procedure is performed during handover between channels controlled by a common BSC (Base Station Controller) in that the SMLC receives the information of handover before the MS has actually handed over to the new channel. This means that for a short period the LMUs are measuring the new channel, which is not the channel presently being served. If the handover is rejected, for example, the new channel might be reserved for another call, this can have potentially disastrous effects on the accuracy of the location measurement and is undesirable.

Therefore, there is a need to improve the accuracy of location calculations during the handover of channels controlled by a common BSC.

### SUMMARY OF THE INVENTION

The embodiments of the present invention seek to address one or more of these problems.

One embodiment of the present invention includes a method of locating user equipment in a communication network. The method includes requesting a location of user equipment which is communicating on a first channel, and initiating a determination of the location of the user equipment. The user equipment for communicating on a second channel is handed over. The determination of the location of the user equipment can be suspended until the handing over has been completed.

Another embodiment of the present invention includes a system for locating user equipment in a communications network. The system includes, for example, a location entity. A controller can be configured to send a request to the location entity for locating user equipment which can be configured to communicate on a first channel. The location entity can be configured to initiate a determination of the location of the user equipment. When the user equipment is being handed over to communicate on a second channel, the location entity can be configured to suspend the determination of the location of the user equipment until the handing over has been completed.

A further embodiment of the present invention includes a location entity for use in a system for locating user equipment in a communications network. The system includes a controller and a location entity which can be configured to receive a request from the controller to locate user equipment which can be configured to communicate on a first channel, and initiate a determination of the location. The location entity can be configured so that when the user equipment is being handed over to communicate on a second channel, determination of the location of the user equipment can be suspended until the handing over has been completed.

### BRIEF DESCRIPTION OF THE DRAWINGS

For a better understanding of the present invention and to show how the same may be carried into effect, reference will now be made by way of example to the accompanying drawings in which:

FIG. 1 shows one embodiment of the present invention;

FIG. 2 shows a second embodiment of the present invention; and

FIG. 3 shows the flow of messages between the BSC and the SMLC in accordance with the main principles of an embodiment of the present invention.

### DETAILED DESCRIPTION OF THE PREFERRED EMBODIMENTS

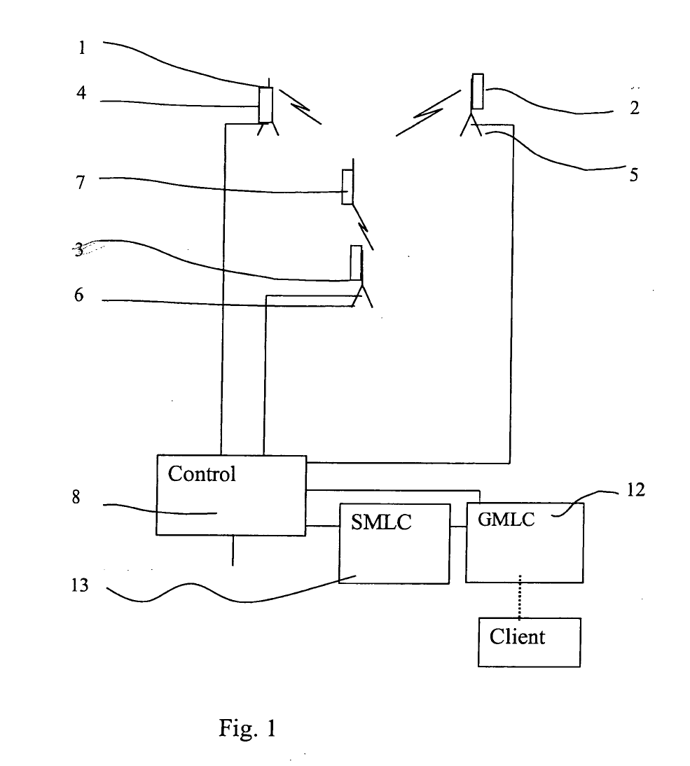

Reference is made to FIG. 1 which is a simplified presentation of some of the components of a cellular system. For example, FIG. 1 shows an arrangement in which three base stations 4, 5 and 6 can provide three radio coverage areas or cells of a cellular telecommunications network.

Each base station 4 to 6 can be configured to transmit signals to and receive signals from the mobile user equipment (UE), for example, a mobile station (MS) 7 via wireless communication. Likewise, the mobile station 7 is able to transmit signals to and receive signals from the base stations. It should be appreciated that a number of mobile stations may be in communication with each base station although only one mobile station 7 is shown in FIG. 1 for clarity.

The cellular systems provide mobility for the users thereof. In other words, the mobile station 7 is able to move from one cell coverage area to another cell coverage area. The location of the mobile station 7 may thus vary in time as the mobile station is free to move from one location (base station coverage area or cell) to another location (to another cell) and also within one cell.

It should be appreciated that the presentation is highly schematic and that in practical implementations the number of base stations would be substantially higher. One cell may include more than one base station site. A base station apparatus or site may also provide more than one cell. These features of a cell depend on the implementation and circumstances.

Each of the base stations 4 to 6 can be controlled by appropriate controller function 8. The controller function may be provided by any appropriate controller. A controller may be provided in each base station or a controller can control a plurality of base stations. Solutions wherein controllers are provided both in individual base stations and in the radio access network level for controlling a plurality of base stations are also known. It should be appreciated that the name, location and number of controller entities depends on the system. For example, a UMTS terrestrial radio access network (UTRAN) may employ a controller node that is referred to as a radio network controller (RNC). In the GSM a corresponding radio network controller entity is referred to as a base station controller (BSC). In this document the term base station controller will be used and is intended to include all of these different examples of a controller mentioned in this paragraph.

The core network of both of the above mentioned systems may be provided with controller entities referred to as a mobile switching center (MSC). It is also noted that more than one controller can be provided in a cellular network.

In this specification all such possible controllers are denoted by the controller 8 of FIG. 1. In other words, the controller 8 may include at least one base station controller and at least one mobile switching center. The controller 8 may be connected to other appropriate elements, such as to another mobile switching center (MSC) and/or a serving general packet radio service support node (SGSN), via a suitable interface arrangement. However, as these do not form an essential part of the invention, the various other possible controllers are omitted from FIG. 1 for clarity.

The communication system is also shown to include means for providing a location service. For example, FIG. 1 shows a location services (LCS) node 12 providing location services for different applications or clients. In general terms, a location services node can be defined as an entity capable of providing client applications with information concerning the geographical location of a mobile station. There are different ways to implement the location services node, and the following will discuss an example that employs the so-called gateway mobile location center (GMLC).

The gateway mobile location center (GMLC) 12 can be configured to receive, via appropriate interface means, predefined information concerning the geographical location of the mobile station 7 from the cellular system. In addition to the information associated with the geographical location, the information provided for the GMLC or node 12 may include the identity (such as an international mobile subscriber identifier: IMSI) or a MSIDSN (a mobile subscriber integrated digital services number) or a temporary identifier of the mobile station 7.

The location information may be provided for the GMLC 12 by means of a serving mobile location center (SMLC) 13. The SMLC or node 13 can be seen as an entity that functions to process location measurement data received from the network in order to determine the geographical location of the mobile station. The location measurement data may be provided by various elements associated with the network such as means of one or several location measurement units 1 to 3 provided in association with at least some of the base stations and/or the mobile station 7. The SMLC or node 13 can process this measurement data and/or some other predefined parameters and input information and/or and to execute appropriate calculations for determining and outputting information associated with the geographical location of the given mobile station 7. The output information will be referenced below as location estimate.

In other words, the information from the various location measurement means can be processed in a predefined manner by node 13. A location estimate may then be provided to the GMLC 12. Authorized clients can then be served by the GMLC 12.

The SMLC or node 13 may be implemented in the radio access network or the core network. If the serving location service node is implemented in the radio access network it may be in direct communication with the access network controller function 8 and the GMLC or node 12. In some applications the SMLC or node 13 may be a part of the access network controller function. If the serving location service node is implemented in the core network it may then be configured to receive the location measurement data from the radio network. For example, by the access network control function 8. The way the location service architecture is arranged is an implementation issue, and will thus not be explained in more detail.

As mentioned above, the location information may be given as a location estimate. The location estimate may be defined on the basis of the measurements regarding the position of the mobile station relative to the base station(s). This information may be produced by specific location measurement units 1 to 3 or similar units implemented on the network side and/or at the mobile station 7 itself.

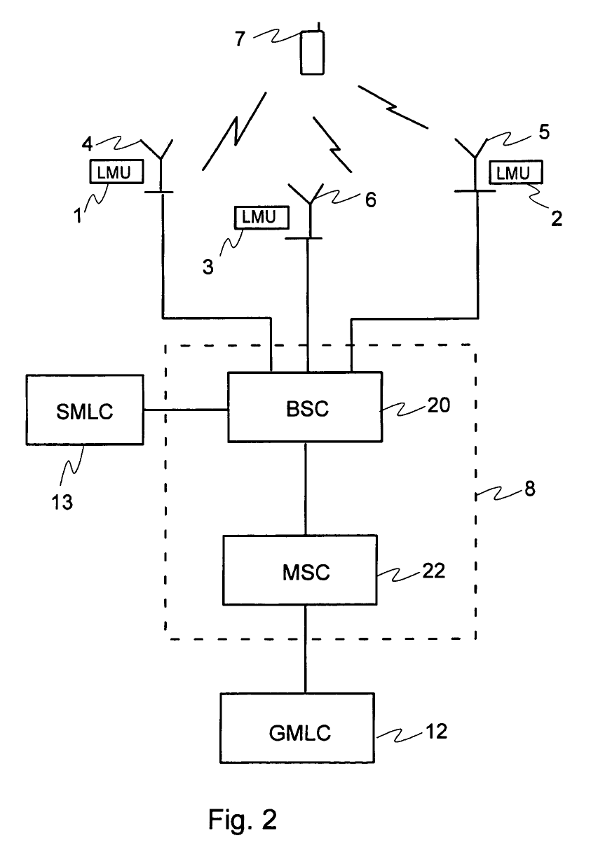

FIG. 2 shows an embodiment of the present invention where the TDOA method is being used and all the communications channels from each of the base stations 4, 5, 6 to the mobile station 7 are controlled by the same BSC controller 20.

It should be appreciated that for U-TDOA (uplink TDOA) each of the base stations 4, 5, 6 can be equipped with a corresponding LMU (Location Measurement Unit) 1, 2, 3. It should also be appreciated that the LMUs can be implemented in different ways. That is, in one embodiment the LMUs can be integrated within the base stations 4, 5, 6 or alternatively they could be implemented as stand-alone units. In the case of stand-alone units the communications between the LMUs and the network is preferably also carried out over the air interface, although in an alternative embodiment the measurements may be conveyed to the network over a fixed link. Moreover, the stand-alone units may have separate antennas or share antennas with an existing base station.

The embodiment illustrated in FIG. 2 includes a handover situation, wherein handover is performed from one communication channel to a different communication channel, but both the channel to be handed over from and the channel to be handed over to are controlled by a common BSC. The single BSC 20 controls a plurality of the channels, which can communicate with the mobile station 7.

Although the SMLC 13 is shown as being connected to the BSC 20 in FIG. 2, it is able to receive measurements from the LMUs 1, 2, 3 either over a radio interface, or otherwise and can initiate procedures for processing these measurements so as to determine the location of the mobile station 7. The determined location can then be sent to the GMLC 12 as described before.

However, a problem can occur during an intra-BSC handover, for example, during the process of handing over from one channel to another channel, which are both controlled by the same BSC 20. This problem can occur when a mobile station is handed over from one base station to another base station and both of the base stations are controlled by the same base station controller. In the past, if an intra-BSC handover occurred during the TDOA location procedure, then the SMLC 13 was informed of a completed handover. This means that the SMLC would get information on the handover before the mobile station has been handed over. Thus for a short period of time, the LMU measurements are for the channel which is to be handed over to, instead of the presently serving channel. However, the channel to be handed over to might be reserved by a call to another mobile station and so the estimate of the location of mobile station 7 can be inaccurate.

An embodiment of the present invention solves this problem by providing a new message “handover started” to indicate that the intra-BSC handover has started.

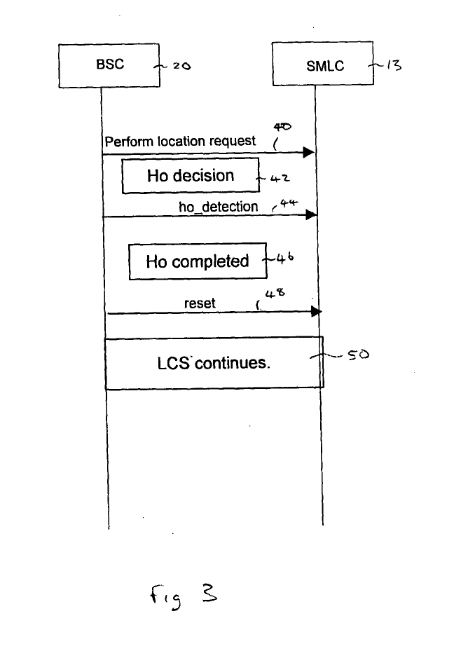

FIG. 3 shows in more detail the flow of messages between the BSC 20 and the SMLC 13 and the states of the system according to the embodiment.

The BSC begins with a request message 40, which requests to the SMLC that the SMLC begins the TDOA location procedure in relation to the mobile station 7 communicating over a first channel. Then state 42 indicates that the system has decided on making a handover so that the mobile station should now communicate over a second communication channel. The BSC 20 then sends a message to the SMLC informing it that the handover has started, using the “ho-detection” message 44. Upon receipt of this message the SMLC immediately stops the location procedures and waits until the handover is completed shown by state 46. The BSC 20 confirms to the SMLC 13 that the handover is completed by sending the “reset” message 48. Once the reset message has been received the SMLC continues the location procedure based on the new handover information. That is, if the handover was successfully completed, the location procedures will be initiated with regards to the second channel, but if the handover was unsuccessful, because for example the second channel was busy, the location services can continue with determining the location of the mobile station on the first channel.

In this way once the SMLC receives the knowledge that the LMU measurements might be corrupted, these measurements can be stopped. In other words the handover procedure can be suspended until the handover has either been successfully completed or has been aborted.

It should be appreciated that while the embodiments have been described in relation to the TDOA method, measurement data for the location service may be obtained by using one or more of the appropriate location determination techniques, for example E-OTD (Enhanced Observed time difference), the signal Round Trip Time (RTT), and timing advance (TA) information, signal strength measurements, and so on. The geographical location information may also be based on use of information provided by a location information services system that is independent from the communication system. Examples of these include the Global Positioning System (GPS), Assisted GPS (A-GPS) or the Differential GPS (D-GPS).

It should be appreciated that while embodiments of the present invention have been described in relation to mobile stations, embodiments of the present invention are applicable to any other suitable type of mobile user equipment.

It is also noted herein that while the above describes exemplifying embodiments of the invention, there are several variations and modifications which may be made to the disclosed solution.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method of locating user equipment in a communication network, the method comprising:
requesting a location of user equipment which is communicating on a first channel;
initiating a determination of the location of the user equipment; and
handing over the user equipment for communicating on a second channel,
wherein said determination of the location of the user equipment is suspended until said handing over has been completed.

2. The method according to claim 1, further comprising receiving a signal indicating that the step of handing over has started.

3. The method according to claim 1, further comprising controlling the first and second channels by a same controller.

4. The method according to claim 3, wherein the step of controlling the first and second channels by a same controller comprises controlling the first and second channels by a base station controller.

5. The method according to claim 4, wherein the base station controller controls a plurality of base stations.

6. The method according to claim 1, wherein the step of requesting a location of comprises requesting a location of a mobile station.

7. The method according to claim 1, wherein determination of the location of the user equipment comprises using a time difference of arrival (TDOA) method.

8. The method according to claim 7, wherein the communications network comprises a wireless communication system having a plurality of base stations, each having a location measuring unit, the initiating step further comprises using signals received at a plurality of location measuring units of respective base stations from said user equipment.

9. A system for locating user equipment in a communications network, the system comprising:
a location entity;
a controller, configured to send a request to the location entity for locating user equipment which is configured to communicate on a first channel, the location entity being configured to initiate a determination of a location of said user equipment,
wherein when said user equipment is being handed over to communicate on a second channel, the location entity is configured to suspend the determination of the location of the user equipment until handing over has been completed.

10. The system according to claim 9, wherein the first and second channels are controlled by a same controller.

11. The system according to claim 9, wherein the location entity comprises a serving mobile location center.

12. The system of claim 9, wherein said location entity is configured to use a time difference of arrival method.

13. A location entity for use in a system for locating user equipment in a communications network, the system comprising a controller, and said location entity being configured to:
receive a request from a controller for locating user equipment which is configured to communicate on a first channel,
initiate a determination of a location,
wherein said location entity is configured so that when the user equipment is being handed over to communicate on a second channel, determination of the location of the user equipment is suspended until said handing over has been completed.

14. A system for locating user equipment in a communication network, the system comprising:
requesting means for requesting a location of user equipment which is communicating on a first channel;
initiating means for initiating a determination of the location of the user equipment;
handing over means for handing over the user equipment for communicating on a second channel,
wherein said determination of the location of the user equipment is suspended until said handing over has been completed.

15. The system according to claim 14, further comprising receiving means for receiving a signal indicating that handing over has started.

16. The system according to claim 14, wherein the first and second channels are controlled by a same controller.

17. The system according to claim 16, wherein the controller comprises a base station controller.

18. The system according to claim 17, wherein the base station controller controls a plurality of base stations.

19. The system according to claim 14, wherein the user equipment comprises a mobile station.

20. The system according to claim 14, wherein determination of the location of the user equipment comprises using a time difference of arrival (TDOA) method.

21. The system according to claim 20, wherein the communications network comprises a wireless communication system having a plurality of base stations, each having a location measuring unit, the initiating means using signals received at a plurality of location measuring units of respective base stations from said user equipment.
